(19) United States
(12) Patent Application Publication
(10) Pub. No.: US 2014/0301074 A1
(43) Pub. Date: Oct. 9, 2014

(54) LED LIGHTING SYSTEM, METHOD, AND APPARATUS

(71) Applicant: LYNK LABS, INC., Elgin, IL (US)

(72) Inventor: Michael Miskin, Sleepy Hollow, IL (US)

(73) Assignee: LYNK LABS, INC., Elgin, IL (US)

(21) Appl. No.: 14/199,328

(22) Filed: Mar. 6, 2014

Related U.S. Application Data
(60) Provisional application No. 61/851,278, filed on Mar. 6, 2013.

(51) Int. Cl. F21S 8/04; F21K 99/00

(52) U.S. Cl. CPC F21S 8/04; F21K 9/17
USPC 362/235; 362/249.02

(57) ABSTRACT

An LED lighting system having at least one LED circuit formed on a PCB assembly, the LED circuit and the PCB assembly forming an LED PCB assembly, and a driver for powering the LED circuit. The LED lighting system includes a cover for attaching to the LED PCB assembly, the cover being configured to allow light emitting from the LED PCB assembly to pass there through.

### RELATED APPLICATIONS

This application claims priority to U.S. Provisional Application No. 61/851,278 filed Mar. 6, 2013—the contents of which are expressly incorporated herein by reference.

### TECHNICAL FIELD

The present invention generally relates to light emitting diode (“LED”) lamps, and more specifically to LED panel lighting devices and systems that can be integrated within ceilings as replacement ceiling tiles or within walls or floors as wall or floor tiles.

### FEDERALLY SPONSORED RESEARCH OR DEVELOPMENT

None.

### BACKGROUND OF THE INVENTION

LEDs are semiconductor devices that produce light when a voltage and current is supplied to them. LEDs are intrinsically DC devices that only pass current in one polarity. Historically LEDs have been driven by constant current or constant voltage DC. More recently, new inventions have demonstrated that LEDs may also be driven direct with low voltage AC or high voltage AC, and with low voltage and high voltage rectified AC.

The increasing adoption and advancement of LED technology has resulted in the development of new LED lighting devices and LED lamps which may replace legacy lamps or light bulbs. LED lighting is, for example, becoming more popular for the replacement of fluorescent tube light fixtures sometimes referred to as “troffers” typically available as 2 ft. square or 2 ft. by 4 ft. fixtures. Presently, LED fixtures exist which are made in the form of a fluorescent tub known as LED tube lights which are capable of replacing the fluorescent tube within the existing fixture. LED tube lights, however, are very costly and have a great weight which can cause problems when integrated. Additionally, LED tube lights do not provide a low profile fixture solution for the replacement of fluorescent tube lighting systems.

Another known device utilizes sheets of acrylic that are edge lit and distribute light from the face of the acrylic. These acrylic LED light panels are then used as replacement for ceiling tiles and do provide a lower profile fixture solution for the replacement of fluorescent tubes. The drawback with acrylic LED light panels is once again weight and cost, which can be high due to various materials and more complex assembly processes.

Whether edge lighting or LED tube lights are utilized, the light pattern and location are fixed within a given troffer or lighting device. Design choice and light distribution is more limited than if the LEDs and LED circuits could be configured in different arrays.

Most LED lighting systems, including those mentioned above with respect to the prior art, include an LED PCB assembly, a heat sink and/or fixture and a power supply or driver. The LED PCB assembly typically includes LED components and/or packages mounted to a printed circuit board along with other components based on the drive scheme and design requirements. The fixture is typically made of aluminum or other thermal conductive material and designed into a form that represents a lighting fixture. A driver and/or power supply which may provide AC or DC power may be provided to provide power to the LED PCB assembly The LED PCB assembly is integrated into the fixture and power supply may be integrated or placed remote to the fixture—collectively providing an LED lighting system.

It would be advantageous to provide LED lighting systems which are low profile, low cost, and low weight which may be used as replacements for troffers and fluorescent bulbs and fixtures.

It would be further advantageous to provide an LED PCB assembly such that it could be used as the LED lighting system, capable of replacing LED lighting systems for fluorescent tubes and/or troffer lighting systems within ceilings and/or ceiling panels without the need for any additional fixtures or requirements.

It would be further advantageous to provide an LED lighting system which may be utilized as a ceiling tile and is capable of allowing for multiple or different LED circuit arrays and configurations so that light produced by the system matches a particular need.

The present invention is provided to solve these and other issues.

### SUMMARY OF THE INVENTION

The present invention is directed to providing a low profile, light weight LED lighting system which is capable of replacing troffers or other existing lighting systems, elements, or fixtures.

According to one aspect of the invention, an LED lighting system is provided. The LED lighting system includes at least one LED circuit formed on a printed circuit board (“PCB”) assembly, the LED circuit and the PCB assembly forming an LED PCB assembly. The lighting system may further include a driver or power supply for powering the LED circuit and a cover for attaching to the at least one LED PCB assembly. The cover may be configured to allow light emitting from the LED PCB assembly to pass there through. The LED PCB assembly, driver, and cover may all be configured to form a ceiling tile, a floor tile, a wall tile, or any other tile or flat lighting system.

According to another aspect of the invention, the LED lighting system may include at least one sheet of thermal conductive material. The LED PCB assembly may be mounted to the at least one sheet of thermal conductive material so that the thermal conductive material may act as a heat sink.

According to another aspect of the invention, the LED PCB assembly may be a chip on board LED package.

According to another aspect of the invention, the LED lighting system may include one or more optics or other light characteristic altering elements placed over at least one LED forming the LED circuit formed on the PCB assembly. Examples of elements which may be included in the lighting system and placed over at least one LED include, but are not limited to, at least one remote phosphor, a lens, an optical diffuser, and an optical film.

According to another aspect of the invention, the driver may be formed as either a part of the LED PCB assembly, for example on the PCB assembly. Alternatively, the driver may be packaged separately from the LED PCB assembly and connected thereto.

According to another aspect of the invention, in order to further facilitate heat dissipation, or in place of a heat sink, the PCB assembly may be constructed using FR4 material or a metal core PCB. The PCB assembly may also be constructed using a flexible PCB.

According to one aspect of the invention, the LED lighting system may be formed as a ceiling tile, a wall tile, or a floor tile.

According to one aspect of the invention, a ceiling tile having at least one LED circuit formed on a PCB assembly, the LED circuit and the PCB assembly forming an LED PCB assembly is provided. The ceiling tile may include a driver for powering the LED circuit, and a cover for attaching to the at least one LED PCB assembly, the cover being configured to allow light emitting from the LED PCB assembly to pass there through.

According to another aspect of the invention, the ceiling tile may include at least one sheet of thermal conductive material. The LED PCB assembly may be mounted to the at least one sheet of thermal conductive material so that the thermal conductive material may act as a heat sink.

According to another aspect of the invention, the LED PCB assembly may be a chip on board LED package.

According to another aspect of the invention, the ceiling tile may include one or more optics or other light characteristic altering elements placed over at least one LED forming the LED circuit formed on the PCB assembly. Examples of elements which may be included in the lighting system and placed over at least one LED include but are not limited to at least one remote phosphor, a lens, an optical diffuser, and an optical film.

According to another aspect of the invention, the driver may be formed as either a part of the LED PCB assembly, for example on the PCB assembly. Alternatively, the driver may be packaged separately from the LED PCB assembly and connected thereto.

According to another aspect of the invention, in order to further facilitate heat dissipation, or in place of a heat sink, the PCB assembly may be constructed using FR4 material or a metal core PCB. The PCB assembly may also be constructed using a flexible PCB.

Other advantages and aspects of the present invention will become apparent upon reading the following description of the drawings and detailed description of the invention.

### BRIEF DESCRIPTION OF THE DRAWINGS

FIG. 1 shows a front view of an embodiment of a lighting system as contemplated by the invention;

FIG. 2 shows a side view of an embodiment of a lighting system as contemplated by the invention;

FIG. 3 shows a front view of an embodiment of an LED PCB assembly as contemplated by the invention;

FIG. 4 shows a front view of an embodiment of an LED PCB assembly as contemplated by the invention;

FIG. 5 shows a front view of an embodiment of an LED PCB assembly as contemplated by the invention;

FIG. 6 shows a front view of an embodiment of an LED PCB assembly as contemplated by the invention;

FIG. 7 shows an embodiment of an LED circuit as contemplated by the invention;

FIG. 8 shows an embodiment of an LED circuit as contemplated by the invention;

FIG. 9 shows an embodiment of an LED circuit as contemplated by the invention;

FIG. 10 shows an embodiment of an LED circuit as contemplated by the invention;

FIG. 11 shows an embodiment of an LED circuit as contemplated by the invention; and

FIG. 12 shows a view of the lighting system shown in FIG. 1 formed as a ceiling tile.

### DETAILED DESCRIPTION OF PREFERRED EMBODIMENTS

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

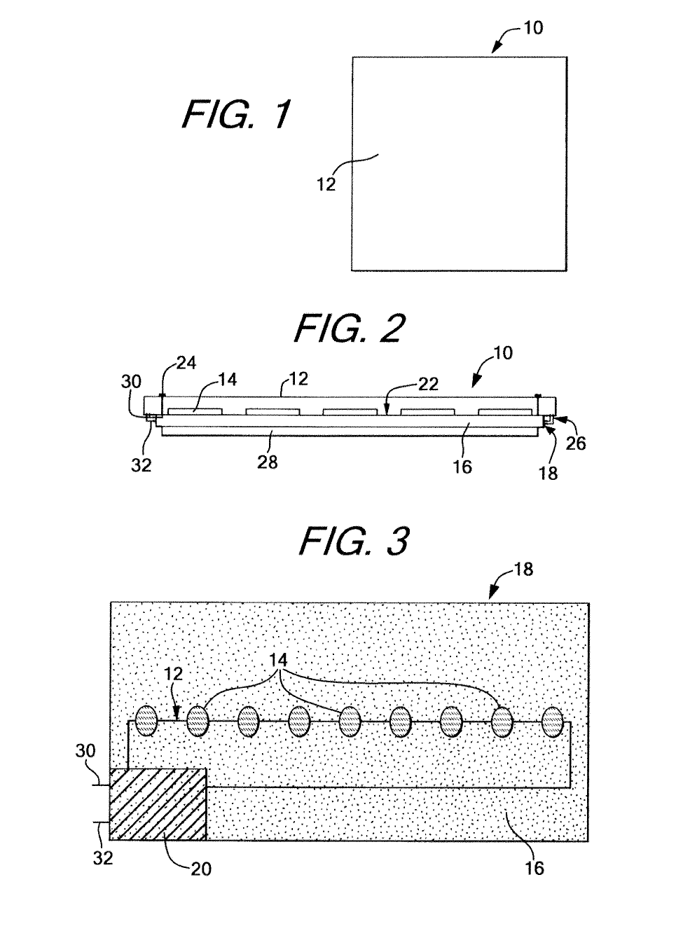

FIGS. 1 and 2 show an embodiment of a lighting system as contemplated by the invention. LED lighting system 10 includes at least one LED circuit 12 having at least one LED 14 formed on PCB board or assembly 16, the at least one LED circuit and the PCB assembly combining to form an LED PCB assembly 18. The LED lighting system includes driver 20 for providing power to the at least one LED circuit. The driver may be packaged separately as driver or power supply, or may be formed on the PCB assembly with the at least one LED circuit. The system further includes a cover 22 which attaches to the LED PCB assembly and is configured to allow light emitting from the LED PCB assembly and the at least one LED circuit formed thereon to pass through. The lighting system may be formed and shaped in a manner which will allow the lighting system to be used as a replacement for, for example, a troffer or other lighting element. The lighting system may be configured or formed as a tile, like, for example, a ceiling tile, a floor tile, or a wall tile capable of providing light from the LED PCB enclosed therein. Any ceiling, floor, or wall tile will utilize the PCB assembly as a base, and may, when not required or desired, not have a cover portion.

In order to allow light from LED PCB assembly 18, and more particularly at LED circuit 12 and LEDs 14 to pass there through, cover 22 may be configured in any number of ways. For example, cover 22 may include apertures which may or may not align with the LEDs in the lighting system. The apertures may allow light to pass through the cover and be emitted outside the system. Alternatively, cover 22 may be constructed from a partially or fully transparent or translucent material which allows light to pass there through. Such materials may be clear or frosted or colored plastics or polymers, or clear or frosted or colored glass. Cover 22 may attach to the LED PCB assembly using fasteners 24, like for example screws or clips, and/or may include a channel or receptacle 26 which can receive and lock onto at least a portion of the PCB assembly.

The look and design of cover 22 may be altered as desired in order to achieve the look and design of any surrounding ceiling, floor, or wall tiles. Any coloring, texturing, shaping, sizing, material, or other characteristics of the cover may be chosen, altered, or manipulated to match any particular design.

PCB assembly 16 may be constructed from materials which provide for heat dissipation from any connected LED circuit 12 or LEDs 14. PCB assembly 16 may be constructed using, for example, FR4 material or a metal core PCB. PCB assembly 16 may also be flexible. In order to either provide or further facilitate heat dissipation, a heat sink 28 which may be, for example a sheet of thermal conductive material, may be included in the light system. LED PCB assembly 18 may be mounted to the heat sink in order to provide heat dissipation.

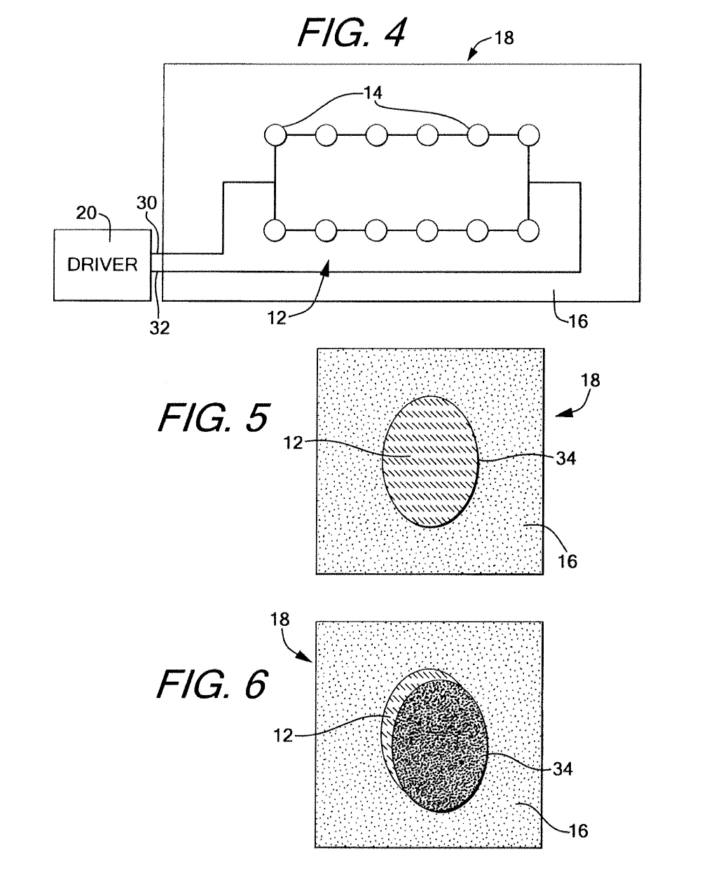

Examples of different embodiments of LED PCB assembly 18 can be seen in FIGS. 3-6, for example. As seen in FIGS. 3 and 4, LED circuit 12 may be formed on PCB assembly 16 having at least one LED 14. PCB assembly 16 may include any wires, traces, or other elements required to connect LEDs 14 which may be integrated on the PCB assembly like a chip, or may be discretely packaged die which are wire bonded or connected together using wire traces formed on the PCB assembly.

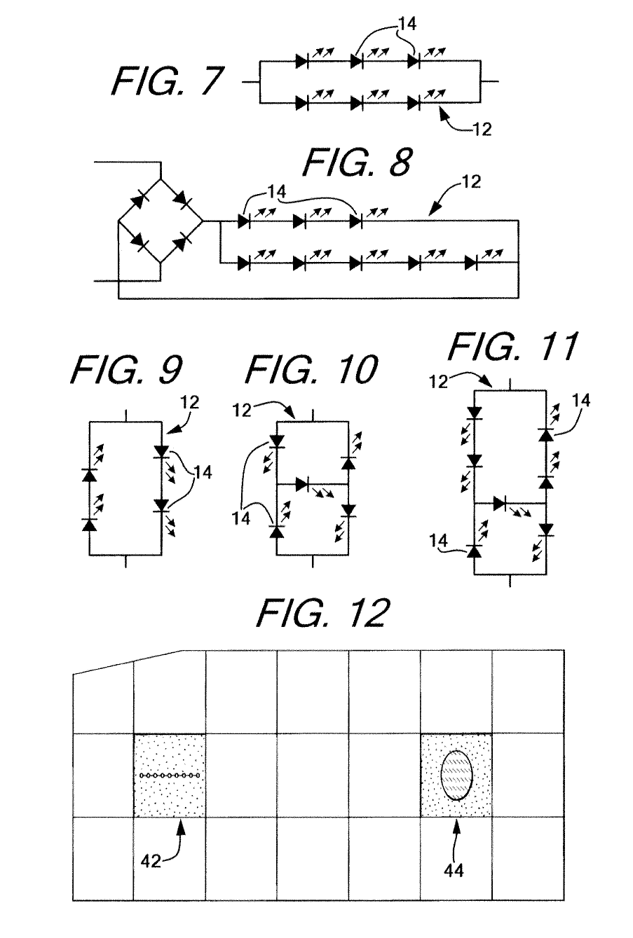

Examples of the circuit formations which may be formed as LED circuit 12 using LEDs 14 can be seen, for example, in FIGS. 7-11. As seen in FIGS. 7-11, LED circuit 12 may include two or more LEDs connected in series for AC or DC power use (see for example, FIGS. 7 and 8), may include two or more LEDs connected in anti-parallel for AC power use (see for example, FIG. 9) or may include multiple diodes or LEDs configured in a bridge or imbalanced bridge configuration having at least one LED connected across the out of the bridge or imbalanced bridge (see for example FIGS. 8, 10, and 11). Traces, wires, or other conductive elements may be provided on the PCB assembly to connect LEDs 14 in any of the circuit configurations shown in FIGS. 7-11 in the LED PCB assembly.

By utilizing LED circuits on a PCB assembly and an LED PCB assembly rather than LED tube lights or edge lit acrylic panels, a greater range of arrays or configurations may be created which will allow the lighting system to be designed to meet particular or more specific light distribution specifications. For example, where target lighting or the like is required, using a PCB assembly and forming an LED PCB assembly may allow for any LEDs and LED circuits to be formed in a center of the PCB assembly and any formed tile, in a circular or other tight configuration. Such an arrangement may provide light directly below the LEDs and LED circuits on a particular area where lighting is desired. Center lit arrangements may also allow for particular effects to be realized in the lighting system, like for example, flat down lighting, back lighting of a particular portion of a tile, or the like. Alternatively, the LED and LED circuits may be formed linearly or spread throughout the tile to produce a light pattern more like a troffer. Rather than be linear, any LED or LED circuits could be formed in a matrix or other formation which may help limit flicker resulting from powering the LEDs and LED circuits with AC power. Utilizing the PCB assembly, and ultimately the LED PCB assembly, as a portion or even potentially as the lighting system and ceiling, wall, or floor tile will provide greater design choice in designing the lighting system insofar as the PCB assembly will provide for connection of the LEDs and LED circuits anywhere on the tile, not just in a tube light or edge of the tile.

The LEDs forming the LED circuit may be configured to emit white light through the use of any optics elements or phosphor, or may alternatively be configured to emit colored light, either directly from the LEDs or again through the use of optics or phosphors. Where multiple series strings are connected in parallel, like for example in FIG. 8, the LED PCB assembly may be capable of emitting light of different colors and have the capability to warm-on-dim as described, for example, in International Pat. Pub. No. 2013/082609 to Lynk Labs, Inc., the contents of which are expressly incorporated herein by reference. As explained therein, providing series strings of LEDs having different color outputs and forward operating voltages based either on the number of LEDs in each string and/or the operating characteristics of the LEDs in each string, and utilizing a dimmer switch to control the voltage and current provided to the series strings, allows for the color temperature of the light output from the totality of the LEDs to be controlled. In addition to potentially being different colors, it is contemplated by the invention that the LEDs may be regular or organic LEDs.

In order to provide AC or DC power to the at least one LED circuit 12 and LED PCB 18, driver 20 may be formed on PCB assembly 16 (as shown for example in FIG. 3), or may be provided within lighting system 10, but packaged externally and electrically connected to LED PCB 18 and LED circuit 12 using wires or other electrical connectors (as shown for example in FIG. 4). Driver 20 may be any known driver capable of driving or controlling LED circuit 12. Though not limited herein, one example of a driver and driver circuitry can be seen in U.S. Pat. No. 7,489,086 to Lynk Labs, Inc, the contents of which are incorporated herein by reference. It should be understood though that the driver of the present invention is not limited to the driver taught in U.S. Pat. No. 7,489,086, and any driver or driver circuitry used in the present invention may include, for example, components capable of rectifying an AC voltage to provide DC voltage, any transformers or electronic transformers to step a provided voltage and/or frequency up or down, any required microcontrollers, transistors, or operational amplifiers, any required inverters, any current limiting or controlling devices, like for example constant current regulators, constant current diodes, resistors, or variable resistors, and any current or voltage smoothing elements like capacitors or inductors. The driver may be matched to a particular LED circuit so as to provide a near ideal amount of power at a desired frequency.

In order to connect LED PCB assembly 18, and consequently LED circuit 12 to a separately packaged driver, or LED PCB assembly having an integrated driver, to a source of power, electrical connectors or contacts 30, 32 may be provided on the LED PCB assembly to connect to either the separately packaged driver or a power source. When the driver is packaged separately from the LED PCB assembly, the driver will provide power to the LED PCB assembly after receiving it from a power source. When the driver is integrated on the LED PCB assembly, the power source will be connected directly to the LED PCB assembly and the integrated driver thereon which will in turn provide power to the at least one LED circuit. The power source may be any known power source, like for example an AC generator, mains power, or a battery.

As an alternative to the LED PCB assemblies shown in FIGS. 3 and 4, as seen in FIGS. 5 and 6 the LED PCB assembly may be formed as a chip-on-board package. The chip-on-board package could be formed as is known in the art, with electrical connectors located on a bottom side of the package to allow the package to plug straight into a power supply or driver.

Regardless of whether the LED PCB assembly resembles those shown in Figs. 3 and 4 or FIGS. 5 and 6, LED PCB assembly 16 may also include various optics or other elements which modify, focus, diffuse, or otherwise affect the characteristics of light emitted from LED circuit 12. For example, as seen in FIG. 6, remote phosphor 34 may be used which may alter the color of light provided by the LEDs. As seen in FIG. 3, lens 36 may be mounted over at least one LED 14 forming LED circuit 22. As seen in FIG. 4, optic film 38 or optic diffuser 40 may be mounted over at least one LED forming LED circuit 22.

FIG. 12 shows an example of lighting system 10 installed as a ceiling tile with cover 22 removed for the sake of clarity—though it should be noted that it is contemplated by the invention that a ceiling tile having no cover may be provided. As seen in FIG. 12, the lighting system may be configured and shaped to be ceiling tile 42 or 44 and used to provide light in place of a troffer or other lighting fixture or device. Because of the heat dissipating abilities of the PCB assembly and any associated heat sink or sheet or thermally conductive material, and the construction of lighting system 10 (or in this case ceiling tiles 42, 44) a lightweight, low profile lighting system is provided. With covers 22 installed, ceiling tiles 42, 44 may be configured to substantially match the other, not light emitting ceiling tiles, with the addition that the covers permit the light emitted from the LED circuit formed on each LED PCB assembly to pass through.

While in the foregoing there has been set forth various embodiments of the invention, it is to be understood that the present invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying claims.

What is claimed is:

1. An LED lighting system comprising:
at least one LED circuit formed on a PCB assembly, the LED circuit and the PCB assembly forming an LED PCB assembly;
a driver for powering the LED circuit;
a cover for attaching to the LED PCB assembly, the cover being configured to allow light emitting from the LED PCB assembly to pass there through,
wherein the LED PCB assembly, the driver, and the cover are configured to form a ceiling tile.

2. The LED lighting system of claim 1 further comprising at least one sheet of thermal conductive material, the LED PCB assembly being mounted to the at least one sheet of thermal conductive material.

3. The LED lighting system of claim 1 wherein the LED PCB assembly is a chip on board LED package.

4. The LED lighting system of claim 1 further comprising at least one remote phosphor mounted over at least one LED forming the at least one LED circuit.

5. The LED lighting system of claim 1 wherein the driver is formed as part of the LED PCB assembly.

6. The LED lighting system of claim of claim 1 wherein the driver is packaged separately from the LED PCB assembly.

7. The LED lighting system of claim 1 further comprising a lens mounted over at least one LED forming the at least one LED circuit.

8. The LED lighting system of claim 1 wherein the PCB assembly is constructed using FR4 material.

9. The LED lighting system of claim 1 wherein the PCB assembly is constructed using a flexible PCB.

10. The LED lighting system of claim 1 wherein the PCB assembly is constructed using metal core PCB.

11. The LED lighting system of claim I further comprising an optical diffuser mounted over at least one LED forming the at least one LED circuit.

12. The LED lighting system of claim 1 further comprising an optical film mounted over at least one LED forming the at least one LED circuit.

13. A ceiling tile comprising:
at least one LED circuit formed on a PCB assembly, the LED circuit and the PCB assembly forming an LED PCB assembly;
a driver for powering the LED circuit; and
a cover for attaching to the LED PCB assembly, the cover being configured to allow light emitting from the LED PCB assembly to pass there through.

14. The ceiling tile of claim 13 further comprising at least one sheet of thermal conductive material, the PCB assembly being mounted to the at least one sheet of thermal conductive material.

15. The ceiling tile of claim 13 wherein the LED PCB assembly is a chip on board type LED package.

16. The ceiling tile of claim 13 further comprising at least one remote phosphor mounted over at least LED forming the at least one LED circuit.

17. The ceiling tile of claim 13 wherein the driver is formed as part of the LED PCB assembly.

18. The ceiling tile of claim of claim 13 wherein the driver is packaged separately from the LED PCB assembly.

19. The ceiling tile of claim 13 further comprising a lens mounted over the at least one LED forming the at least one LED circuit.

20. The ceiling tile of claim 13 wherein the PCB assembly is constructed using FR4 material.

21. The ceiling tile of claim 13 wherein the PCB assembly is constructed using a flexible PCB.

22. The ceiling tile of claim 13 wherein the at least one LED PCB assembly is constructed using metal core PCB.

23. The ceiling tile of claim 13 further comprising an optical diffuser mounted over at least one LED forming the at least one LED circuit

24. The ceiling tile of claim 13 further comprising an optical film mounted over at least one LED forming the at least one LED circuit
